(19) United States
(12) Patent Application Publication
(10) Pub. No.: US 2018/0127894 A1
(43) Pub. Date: May 10, 2018

(54) COMPOSITE FIBER FOR INORGANIC BINDER APPLICATIONS

(71) Applicant: Construction Research & Technology, GmbH, Trostberg (DE)

(72) Inventors: Burkhard WALTHER, Taching am See (DE); Bernhard FEICHTENSCHLAGER, Traunstein (DE)

(21) Appl. No.: 15/572,203

(22) PCT Filed: Apr. 19, 2016
(86) PCT No.: PCT/EP2016/058596

§ 371 Date: Nov. 7, 2017

(30) Foreign Application Priority Data
May 8, 2015 (EP) 15166895.1

(51) Int. Cl. D01D 5/42; D01D 5/22; D01D 5/32; D01F 8/06; C04B 16/06; C04B 20/06; C04B 28/00; C04B 28/02; C04B 28/14

(52) U.S. Cl. CPC D01D 5/426; D01D 5/22; D01D 5/32; D01F 8/06; C04B 28/14; C04B 16/0641; C04B 20/068; C04B 28/006; C04B 28/02; C04B 16/0633

(57) ABSTRACT

Fibers of diverse materials find widespread use in inorganic binder compositions to improve the properties of the final cured composite materials. When using high amounts of fiber in inorganic binder slurries, problems arise due to the loss of workability because of unevenly distributed fiber content. The novel fibers according to the invention allow the use of large amounts of fiber without loss of workability and are particularly useful to control the rheology of the composite slurry mixtures.

### FIELD OF INVENTION

Fiber containing composite materials find widespread use for example in coatings, floor coverings, tires, synthetic leather, and in cementitous or inorganic binder composites for reinforcement, cracking-control and shrinkage reduction. Wenn short fiber filaments or bundles or generally fiber filaments of varying lengths are used or need to be dosed and mixed into a composite mixture, the handling of such fiber preparations tends to be difficult. Fibers have the property to assemble into fiber-balls, -clusters or -nests and therefore generally show low dispersability in mixtures. Especially when small fiber filaments, such as microfiber, are applied the respective dispersability of the fibers in inorganic binder slurries is challenging. This problem is most evident for short polymeric fibers that are of commercial interest because of their better durability compared to steel-fibers.

Cut staple fibers are used in a variety of applications ranging from textiles, non-wovens, carpets, upholstery, filters, reinforcements for composites, or even hydraulic fracturing among many others. In all of these applications the dry staple fibers are difficult to handle due to the large volume of randomly oriented individual fiber filaments. Also, their ability to get airborne may pose a health hazard due to inhalation (e.g. asbestos, glass fibers, polymeric fibers etc.) and cause respiratory diseases or even cancer in humans handling such fibrous material.

In order to facilitate safe handling the fibers are used as or in suspension, either in aqueous or organic solvents, or polymeric/resin media. In order to make the fiber suspensions, the fiber is added into mixing tanks from bags. Effective mixing is required for proper dispersion, especially with glass or polymer fibers in organic media or hydrophobic fiber in water. Under these conditions they have a natural tendency to cluster and unevenly distribute throughout the media matrix. Generally dispersing aids may be employed. Additionally rheology modifiers may be added to the suspension in order to obtain pumpable suspensions.

U.S. Pat. No. 5,019,211 discloses temperature sensitive bicomponent synthetic fiber that curl when heated for making creped tissue webs. These fibers are utilized in the paper industry to increase the bulk of cellulosic fiber products.

JP2000203906 describes fiber for reinforcing cement, wherein the fibers are covered or coated by a decomposable resin. The resulting fiber is of coiled, elliptical or polygonal shape. The procedure though is hampered by the complicated and demanding preparation of the fibrous material.

EP 2206848 discloses capsules made from fiber formed as coiled elements that are further wrapped or covered with water-soluble glue. The capsules are used for the introduction of reinforcing fiber during production of reinforced concrete. The capsules are added to dry concrete mixtures, distribute evenly and after the addition of water loose the covering capsule and thereby release the fiber into the concrete mixture. This method is also characterized to be demanding since it requires several preparatory steps, like the initial coiling of fiber followed by capsule preparation.

The present state of the art technology therefore does not provide or achieve simple and satisfactory dispersion of reinforcement fiber in any concrete or inorganic binder mixture. In many cases cluster of unevenly distributed fiber lead to insufficient reinforcement performance and potentially negative appearance of the surface of respective cured concrete products. Thus, there is the continued need to improve and provide simple, safe, cost efficient and effective preparation, handling, delivery, and dispersion of short staple fibers for use in slurry preparations in general and for inorganic binder mixture in particular.

### BACKGROUND OF INVENTION

This invention deals with the fundamental issue that appears when short fibers are used in inorganic binder formulations or mixtures, such as cementitious, binder mixtures, incl. alumosilicate, gypsum, or geopolymer-based mixtures. In principle, the performance of the resulting cementitious fiber composites with regard to stability could basically be improved simply by adding higher amounts of fiber or increasing the length of the fiber filaments. Longer fibers result in a higher interfacial friction (fiber bridging strength) and thus higher pull-out resistance in the final composite. However this also influences the rheology of the inorganic binder mixtures. The flowability and thus workability of the mixture decreases dramatically upon increasing fiber content or fiber length.

Also the tensile strain capacity of the resulting cured inorganic binder material is closely associated with fiber dispersion and ultimately determines the fiber bridging strength. There is a close correlation between rheological parameters, i.e. flow rate and plastic viscosity of mortar or concrete, and fiber content and degree of fiber dispersion.

By influencing the degree of fiber dispersion in the inorganic binder mixtures the micromechanics of the material may be tailored to optimize the rheological properties of the respective material. This problem may be solved in providing a methodology of ingredient-tailored approach combined with improved chemistry for rheology control of inorganic binder mixtures. This approach is schematically shown in FIG. 1.

Basically a multicomponent fiber is provided by the present invention. Such multicomponent fibers are composed of at least two components distributed over the entire length of the fiber. Each component may have different physical or chemical properties and may belong to either the same type of polymer or be a totally different polymer type. A bicomponent fiber may for example be obtained by either coextruding two polymers into one single strand, the different properties of both polymers are thereby combined. The resulting newly created bicomponent fiber will have new properties and may be applied in a variety of different applications. The properties and possible applications depend on both the properties of the individual polymer components and the combination of the different polymers and potential additives, as well as on the configuration of the final multicomponent fiber. Such a multicomponent fiber may also be obtained by layering or sandwiching at least two or more polymer species over each other and slicing the resulting foil into individual fiber elements. Generally the separate polymers occupy an equal part of the fiber surface. Depending on the chosen polymers, the fiber may develop more crimp than other possible configurations of multicomponent fibers, such as sheath/core, pie wedge, island/sea or other possible configurations or combinations of individual polymer components. Thereby it is possible to produce a tape-fiber which is hydrophilic on one side and hydrophobic on the other side. The fiber is curled in the dry state and stretches within a certain time span when exposed to water, for example in an inorganic binder slurry, to effect its function as reinforcement component in the cementitious matrix. Based on different hygroscopic expansion coefficients the varying expansion of the polymers under humid conditions leads to an unilateral extension and ultimately to stretching or uncurling of the originally curled fiber. Ultimately the fiber in the curled state and therefore reduced surface area influences the rheology less than a stretched fiber with exposed surfaces. Consequently higher fiber contents in inorganic binder slurries, or general in any slurry type, under maintenance of workability are possible.

### DESCRIPTION OF THE INVENTION

Described herein are solutions to the problem related to managing volume issues of and for handling polymer fibers, such as short and/or cut staple fibers. In one embodiment, the polymer fibers are hydrophobic polymer fibers. In another embodiment, the staple fibers are compacted into bundles using an adhesive or binder.

For the experiments a uniaxially stretched polypropylene (PP) sheet with 40 micron thickness was used. Alternatively other dimensions or any polyolefine such as polyethylene (PE) may also be used. The hydrophilic coating on one side was realized by initially oxidizing this one side of the sheet with, for example, persulfate, permanganate, dichromate, ozone, electrochemically, via plasma-treatment or any other method of oxidizing applicable by a skilled person. The oxidation is necessary to provide adhesion of a second polymer. The second polymer, selected from a hydrophilic and swellable polymer such as polyvinylalcohol (PVA), polyacrylic acid (PA) to name only two, but not excluding any other hydrophilic and swellable polymer, was applied from solution onto the oxidized side of the polymer sheet, thereby creating a layer on top of this first polymer sheet. BaSO₄ or other inorganic fillers may be added to the polymer layer to tune the density. Generally any material with a density over 1.0 gram per liter may be used. In an alternative embodiment the sheet was then cut in the pre-stretched direction (FIG. 1) to obtain individual fiber elements. The hydrophilic polymer layer has the function to uptake and release water and thus swell or shrink under the respective conditions. This leads to reversible stretching and curling of the bicomponent fiber. Depending on layer thickness the fiber curls and in some cases with more than one loop. As the skilled person will recognize the bicomponent fibers of the present invention as described above are composed of at least two components, but may als be composed of more than two, such as three or more layers that are arranged in a layered or sandwich-like structure, i.e the fiber elements resemble layered or sandwich-structured composites. Further, in the bicomponent, two-layered situation the ratio of the layer thickness of the first or upper layer to second or lower layer is generally in the range of 1 to 2 or more, but not greater than 3.

The resulting multicomponent fibers were added to cementitious slurry preparations revealing good initial flowability of such cementitious slurry preparations with sustained uniform distribution of the fiber in the cementitious matrix. The workability of the fiber containing cementitious slurry preparations can be maintained where the fiber content lies in the range of 0.5 to at least 5 weight percent, optimally in the range of 1 to 3 weight percent.

Items

Item 1: Bicomponent fiber comprising first polymer as a first component and a second polymer as a second component with differing hygroscopic expansion coefficients.

Item 2: Bicomponent fiber of item 1, wherein the two components are arranged in layered or sandwich-like structure or resemble a layered or sandwich-structured composite.

Item 3: Bicomponent fiber of item 2, wherein the ratio of the layer thickness of the first or upper layer to second or lower layer is not greater than 3.

Item 4: Bicomponent fiber of one of the items above, wherein the first polymer is hydrophobic, preferably selected from polyolefines such as polyethylene or polypropylene and the second polymer is hydrophilic, preferably selected from polyvinyl alcohol or polyacrylic acid.

Item 5: Bicomponent fiber of one of the items above, wherein the first polymer is polypropylene and the second polymer is polyvinyl alcohol.

Item 6: Method of manufacture of bicomponent fibers of any of items 1 to 5, comprising the following steps:
uniaxially stretching of the first polymer
oxidizing one side of the first polymer
coating the oxidized side of the first polymer with the second polymer
drying the resulting bicomponent substrate
cutting the dried bicomponent substrate into fibers of desired dimensions.

Item 7: Use of a fiber of any of the items 1 to 5 or item 14 to 15 or obtained by method of item 6 or item 13 as an additive in inorganic binder formulations or compositions.

Item 8: Use of item 7 wherein the inorganic binder formulations or compositions comprises cement, aluminosilicate, gypsum or geopolymer-based binders.

Item 9: Use of a fiber of any of the items 1 to 5 or item 14 to 15 or obtained by method of item 6 or item 13 to control the rheology of hydraulic binder compositions

Item 10: Use of a fiber of any of the items 1 to 5 or item 14 to 15 or obtained by method of item 6 or item 13 in the field of civil engineering

Item 11: Use of items 10 for the manufacture of fiber reinforced inorganic binder compositions such as reinforced concrete mixtures.

Item 12: Cured building bodies obtained by the use according to items 10 or 11.

Item 13: A process for making a bicomponent fiber, wherein said fiber comprises a first hydrophobic polymer, preferably selected from polyolefines, and a second hydrophilic polymer, preferably selected from polyvinyl alcohol or polyacrylic acid, comprising the following steps:
uniaxially stretching a sheet of a first polymer,
oxidizing one side of a sheet of said first polymer,
coating the oxidized side of a sheet of said first polymer with said second polymer,
drying the resulting bicomponent substrate,
cutting the dried bicomponent substrate into fibers of desired dimensions.

Item 14: Bicomponent fiber obtained according to item 12, wherein the first hydrophobic polymer is polypropylene and the second hydrophilic polymer is polyvinyl alcohol.

Item 15: Bicomponent fiber of item 13 or obtained according to item 12, wherein the ratio of the layer thickness of the first or upper layer to second or lower layer is not greater than three.

### EXAMPLES

The bicomponent fiber preparation comprises the following steps:

Step 1) Selection of polypropylene (PP)-sheet

Two different thicknesses of uniaxially oriented PP sheets, 100 micron and 40 micron thick, were selected for fiber production.

Step 2) Unilateral hydrophilation of PP-foil

In alternative experiments selected sheets were treated with 5% dipotassiumperoxodisulphate, 5% potassiumpermanganate, or 1% potassiumdichromate solution for 2-6 hours at 60-80° C. (6h at 60° C. or for 2 h at 80° C.). Afterwards the surface was washed with water and the treated side of the sheet had turned hydrophilic.

Step 3) The hydrophilic side of the sheet was coated with a hydrophilic polymer (water soluble or non-soluble) selected from a polyvinylalcohol (PVA), polyacrylic acid (PA) or the like.

### Example 1

A 40 micron thick PP sheet oxidized with 5% dipotassiumperoxodisulphate solution for 6 h at 60° C. was coated with an aqueous saturated solution of polyvinylalcohol (e.g. Mowiol 4-88; Kuraray Ltd.) and dried at 70° C. After this procedure the sheet was longitudinal cut into fibers which curled or curled immediately (FIG. 2). The resulting ring-like-fiber elements uncurled or stretched after 30 min.-60 min. when put into water. (FIG. 3). When doubling the amount of hydrophilic polymer solution the resulting layer on the PP was doubled in thickness, resulting in a stronger curling effect and a longer time (more than 60 min) for uncurling when placed in water.

### Example 2

A 100 micron thick PP sheet oxidized with 5% dipotassiumperoxodisulphate solution for 6 h at 60° C. was coated with an aqueous saturated solution of polyvinylalcohol (e.g. Mowiol 4-88; Kuraray Ltd.) plus 10% barium sulfate powder and dried at 70° C. After this procedure the sheet was cut into fibers in the longitudinal direction which immediately curled. When these curled, ring-like fibers were put into water, they uncurled or stretched.

### Example 3

A 40 micron thick PP foil oxidized with 5% dipotassiumperoxodisulphate solution for 6 h at 60° C. was coated with an aqueous saturated solution polyacrylic acid (e.g. Sokalan PA 40 or Sokalan CP 12 S; BASF SE) and dried at 70° C. After this procedure the sheet was cut into fibers in the longitudinal direction which immediately curled. When these ring-like-fibers were placed into water, they uncurled or stretched as described above.

### Example 4

A 40 micron thick PP foil oxidized with 5% dipotassiumperoxodisulphate solution for 6 h at 60° C. was coated with an aqueous saturated solution polyacrylic acid (e.g. Sokalan PA 40 or Sokalan CP 12 S from BASF SE) plus 10% barium sulfate powder and dried at 70° C. After this procedure the sheet was cut into fibers in the longitudinal direction which immediately curled. When these ring-like-fibers were placed into water, they uncurled or stretched as above.

### Example 5

A 40 micron thick PP sheet was oxidized with 5% dipotassiumperoxodisulphate solution for 6 h at 60° C. and subsequently coated with a dispersion of polyvinylacetate-co-polyethylene and dried at 70° C. After this procedure the sheet was cut into fibers in the longitudinal direction which immediately curled. When these ring-like-fibers were placed into water, they uncurled or stretched as described above.

### Example 6

As in Examples 1 to 6 a 40 micron thick PP sheet as a first polymer will be oxidized with 5% dipotassiumperoxodisulphate solution for 6 h at 60° C. and will be coated with an aqueous saturated solution of a second polymer such as polyvinylalcohol (e.g. Mowiol 4-88; Kuraray Ltd.) in varying thicknesses of up to 120 microns or, alternatively, the PP sheet will be coated with an aqueous saturated solution polyacrylic acid (e.g. Sokalan PA 40 or Sokalan CP 12 S; BASF SE) in varying thicknesses of up to 120 microns or alternatively the PP sheet will be coated with a dispersion of polyvinylacetate-co-polyethylene in varying thicknesses of up to 120 microns and in each case the resulting sheets will be dried at approximately 70° C. 10% barium sulfate powder can optionally be added to the solution of the second polymer. After this procedure the obtained sheets will be cut into fibers in the longitudinal direction which immediately will curl. When these ring-like-fibers are placed into water, they will uncurl or stretch as described above.

Application Test

Within an application test the rheological behavior of the invented fiber was compared to standard fiber in a mortar formulation.

As cementitious matrix a high density mortar formulation was used to give a high strength matrix for composites Therefore 430 g Portland cement (CEM I, Schwenk Zement KG, Mergelstetten), 880 g Mineral Coal Fly Ash (L-10, Evonik Industries), 150 g quartz sand (0-0.3 mm), 150 g quartz flour (W12), 300 g water and 4.3 g superplastiziser (Melflux 2641; BASF), as well as 0.5 g stabilizer (Melvis F40; BASF) were mixed.

Fibers prepared according to example 1 were used. The cut fibers had a dimensions of 40 mm×1.5 mm (Fiber 2, FIG. 4). As comparative example untreated fiber with the same dimensions was used (Fiber 1, FIG. 4).

The mortar mix was prepared and the fibers mixed into the slurry resulting in a 1 weight % fiber dispersion in cementitious slurry. It may be envisaged to add up to 5 weight % of fiber to cementitious compositions with retained workability of the the resulting slurry. The slump-flow-test was performed using a Haegermann Funnel on the basis of DIN 1060 and 1164 standards:

Results:

Spread Value of pure mortar matrix: 313 mm

Spread Value of untreated fiber containing slurry: 282 mm

Spread Value of invented fiber containing slurry: 305 mm

Upon addition of standard, extended fiber the flowability and workability of the mortar decreases substantially, generally more than 10%. In comparison the workability of the slurry containing inventive curled bicomponent fibers the workability only decreases by not more than 10%. These results illustrate the unexpected improvement of flowability and workability of curled fiber containing cementitious binder slurries compared to conventional untreated fiber sample. It will be appreciated that these examples are solely for illustrative purposes and are not to be construed as limiting the scope of this invention.

### BRIEF DESCRIPTION OF THE DRAWINGS

FIG. 1: Schematic representation of generation of splice-fibers from an oriented PP sheet that was hydrophilically coated on one side and curled upon drying.

FIG. 2: A curled fiber after drying.

FIG. 3: Spliced fibers obtained from an unilaterally hydrophilic coated and oriented PP sheet that curled upon drying.

FIG. 4: Fiber 1 (a), Fiber 2 (b)

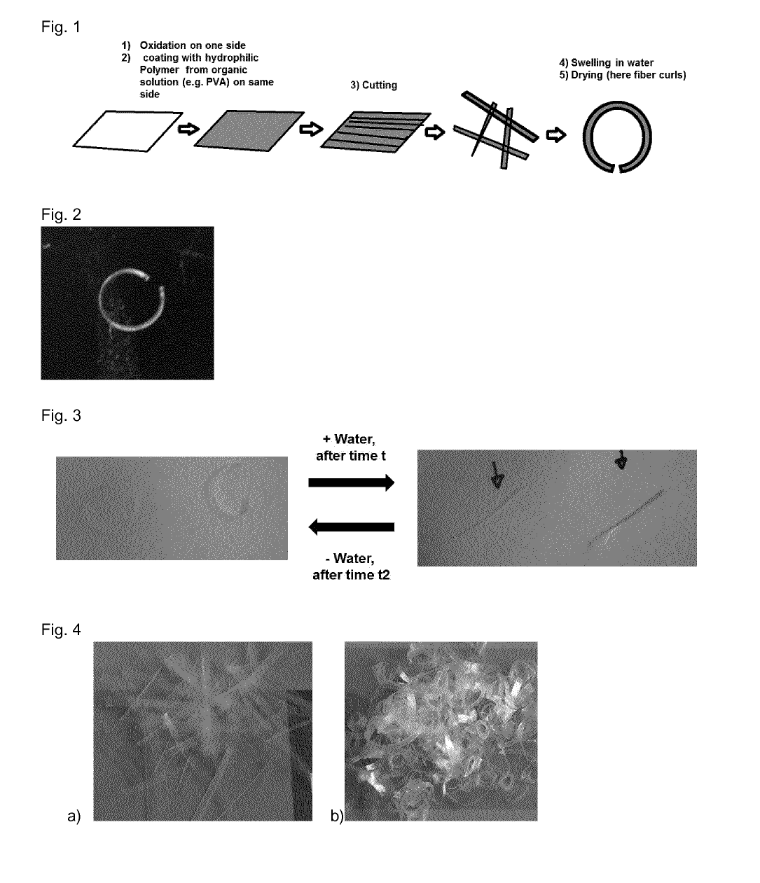

1. A process for making a bicomponent fiber, wherein said fiber comprises a first hydrophobic polymer, optionally selected from polyolefins, and a second hydrophilic polymer, optionally selected from polyvinyl alcohol or polyacrylic acid, comprising the following steps:
uniaxially stretching a sheet of said first polymer,
oxidizing one side of the sheet of said first polymer,
coating the oxidized side of the sheet of said first polymer with said second polymer to form a bicomponent substrate,
drying the bicomponent substrate, and
cutting the dried bicomponent substrate into fibers of desired dimensions.

2. A bicomponent fiber obtained according to the process of claim 1, wherein the first hydrophobic polymer is polypropylene and the second hydrophilic polymer is polyvinyl alcohol.

3. A bicomponent fiber obtained according to the process of claim 1, wherein the ratio of layer thickness of a first or upper layer of the bicomponent fiber to a second or lower layer of the bicomponent fiber is not greater than three.

4. A method of utilizing the bicomponent fiber obtained by the process of claim 1 comprising mixing the bicomponent fiber as an additive in inorganic binder formulations or compositions.

5. The method of claim 4 wherein the inorganic binder formulations or compositions comprises cement, aluminosilicate, gypsum or geopolymer-based binders.

6. A method of utilizing the bicomponent fiber obtained by the process of claim 1 comprising controlling the rheology of hydraulic binder compositions by adding thereto said bicomponent fiber.

7. (canceled)

8. The method of claim 6 wherein the first hydrophobic polymer is polypropylene and the second hydrophilic polymer is polyvinyl alcohol.

9. The method of claim 6 wherein the ratio of layer thickness of a first or upper layer of the bicomponent fiber to a second or lower layer of the bicomponent fiber is not greater than three.

10. The method of claim 4 wherein the first hydrophobic polymer is polypropylene and the second hydrophilic polymer is polyvinyl alcohol.

11. The method of claim 4 wherein the ratio of layer thickness of a first or upper layer of the bicomponent fiber to a second or lower layer of the bicomponent fiber is not greater than three.
